(19) United States
(12) Patent Application Publication
(10) Pub. No.: US 2020/0014591 A1
(43) Pub. Date: Jan. 9, 2020

(54) METHOD AND SYSTEM OF DEVICE DEPLOYMENT INTEGRATING WITH AUTOMATIC CONFIGURATION AND ASSET MANAGEMENT

(71) Applicant: Hitachi, Ltd., Tokyo (JP)

(72) Inventor: Daisuke ITO, Cupertino, CA (US)

(73) Assignee: Hitachi, Ltd.

(21) Appl. No.: 16/029,439

(22) Filed: Jul. 6, 2018

(51) Int. Cl. H04L 12/24; H04L 29/08

(52) U.S. Cl. CPC H04L 41/0813; H04L 67/18

(57) ABSTRACT

Example implementations described herein are directed to systems and methods for provisioning an edge device where for a smart device located in proximity to the edge device, including obtaining, by the smart device, a photo of a physical identifier of the edge device; determining a location from the smart device; transmitting information indicating the physical identifier and the location to a data server; receiving a set of configuration information; and providing the set of configuration information to the edge device, wherein the edge device is configured based on the set of configuration information independent of communication with the data server.

### BACKGROUND

### Field

The present disclosure relates generally to asset management, and more specifically, to device deployment with automatic configuration and asset management.

### Related Art

Locations or work sites employing an Internet of Things (IoT) system can involve hundreds or thousands of edge devices such as sensors and small computer devices. Edge devices are routinely newly deployed and re-deployed in systems which require laborious and time consuming registration and configuration workflows for the edge devices to operate properly. For example, each edge device is typically requires separate network configuration in order to function.

IoT devices are typically configured by operators when they physically distributed to a location at a work site. Device deployment can involve a multitude of different configurations and installations of programs for a number of different sub-systems of an IoT system that conventionally requires considerable Information Technology (IT) and operational expertise and time.

Further, the devices can come from different vendors or manufactures that required different configuration workflows to integrate into the systems and separate registration into asset management systems. For example, management of IoT edge devices can include not only cyber managements such as network configuration changes on the devices but also physical managements such as location changes through the lifetime of the device.

In related art IoT systems, such as U.S. Pat. No. 8,010,640, titled “Systems and methods for auto-configuration of a generic data device coupled to a utility meter on a wireless network”, physical management processes are separate from configuration process for each IoT device which requires considerable time and effort on the part of operators to keep a system with hundreds or thousands of devices located throughout a location or work site.

Conventional related art IoT systems are typically only compatible with proprietary devices with limited configuration functionality. Related art approaches use vendor preconfigured devices that are not generally compatible with non-vendor devices, non-vendor IoT systems, and/or customized IoT systems. Moreover, related art preconfigured devices do not include integrated asset management and typically still require location specific configuration and installation.

Accordingly, conventional IoT device management approaches fail to provide acceptable solutions for efficient device deployment for a variety device with robust configuration and installation, and asset management integration.

### SUMMARY

An example implementation includes a method for provisioning an edge device where for a smart device located in proximity to the edge device, the method includes obtaining, by the smart device, a photo of a physical identifier of the edge device; determining a location from the smart device; transmitting information indicating the physical identifier and the location to a data server; receiving a set of configuration information; and providing the set of configuration information to the edge device, wherein the edge device is configured based on the set of configuration information independent of communication with the data server.

Aspects of the present disclosure can include a system with a memory and processing device configured for device deployment with automatic configuration and asset management. For a smart device located in proximity to an edge device, the processing device is configured to obtain a photo of a physical identifier of the edge device; determine a location from the smart device; transmit information indicating the physical identifier and the location to a data server; receive a set of configuration information; and provide the set of configuration information to the edge device, wherein the edge device is configured based on the set of configuration information independent of communication with the data server.

Aspects of the present disclosure can include a non-transitory computer readable medium storing instructions to provision an edge device. For a smart device located in proximity to the edge device, the instructions are to obtain a photo of a physical identifier of the edge device; determine a location from the smart device; transmit information indicating the physical identifier and the location to a data server; receive a set of configuration information; and provide the set of configuration information to the edge device, wherein the edge device is configured based on the set of configuration information independent of communication with the data server.

Aspects of the present disclosure can include a means for provisioning an edge device, where for a smart device located in proximity to the edge device, means for obtaining, by the smart device, a photo of a physical identifier of the edge device; means for determining a location from the smart device; means for transmitting information indicating the physical identifier and the location to a data server; means for receiving a set of configuration information; and means for providing the set of configuration information to the edge device, wherein the edge device is configured based on the set of configuration information independent of communication with the data server.

### BRIEF DESCRIPTION OF DRAWINGS

FIG. 1 illustrates a system diagram of an example automatic device configuration and registration system in accordance with an example implementation.

FIG. 2 illustrates an example sequence diagram for deploying a new edge node using the automatic device configuration and registration system in accordance with an example implementation.

FIG. 3 illustrates an example directory table in accordance with an example implementation.

FIG. 4 illustrates an example asset database table in accordance with an example implementation.

FIG. 5 illustrates an example configuration database table in accordance with an example implementation.

FIG. 6 illustrates a system diagram of an example smart device in accordance with an example implementation.

FIG. 7 illustrates a system diagram of an example edge device in accordance with an example implementation.

FIG. 8 illustrates a system diagram of an example core server device in accordance with an example implementation.

FIG. 9 illustrates a system diagram of an example directory server in accordance with an example implementation.

FIG. 10 illustrates a flow chart of an example smart device process in accordance with an example implementation.

FIG. 11 illustrates a flow chart of an example edge device process in accordance with an example implementation.

FIG. 12 illustrates a flow chart of an example directory server process in accordance with an example implementation.

FIG. 13 illustrates a flow chart of an example core server process in accordance with an example implementation.

FIG. 14 illustrates a system diagram of an example automatic device configuration and registration system with limited connectivity in accordance with an example implementation.

FIG. 15 illustrates a sequence diagram of an example new edge node deployment process with limited connectivity in accordance with an example implementation.

FIG. 16 illustrates a system diagram of an example smart device in accordance with an example implementation.

FIG. 17 illustrates a flow chart of an example smart device process in accordance with an example implementation.

FIG. 18 illustrates a flow chart of an example directory server process in accordance with an example implementation.

FIG. 19 illustrates an example directory table in accordance with an example implementation.

FIG. 20 illustrates a system diagram of an example automatic device configuration and registration system in accordance with an example implementation.

FIG. 21 illustrates a sequence diagram of an example new edge node secure deployment process in accordance with an example implementation.

FIG. 22 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The present disclosure relates generally to IoT devices, and more particularly, to automating deployment provisioning including both configuration of devices and maintenance of asset management databases.

In an example implementation, a method for provisioning an edge device where a smart device is located in proximity to the edge device, the method includes obtaining, by the smart device, a photo of a physical identifier of the edge device; determining a location from the smart device; transmitting information indicating the physical identifier and the location to a data server; receiving a set of configuration information; and providing the set of configuration information to the edge device, wherein the edge device is configured based on the set of configuration information.

In an example implementation, the edge device may have limited or lack network connectivity prior to the configuration. In an example aspect of the present disclosure, the edge device can be provisioned independent of direct communication between the edge device and a data server (i.e., a directory server). In some examples, the edge device may have limited connectivity to the smart device (e.g., wired, Bluetooth, near field communication, barcode, infrared, etc.).

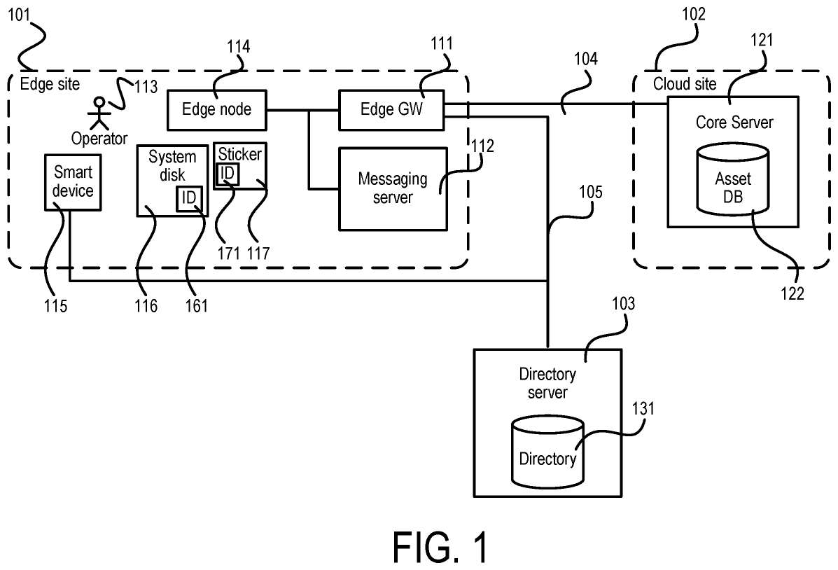

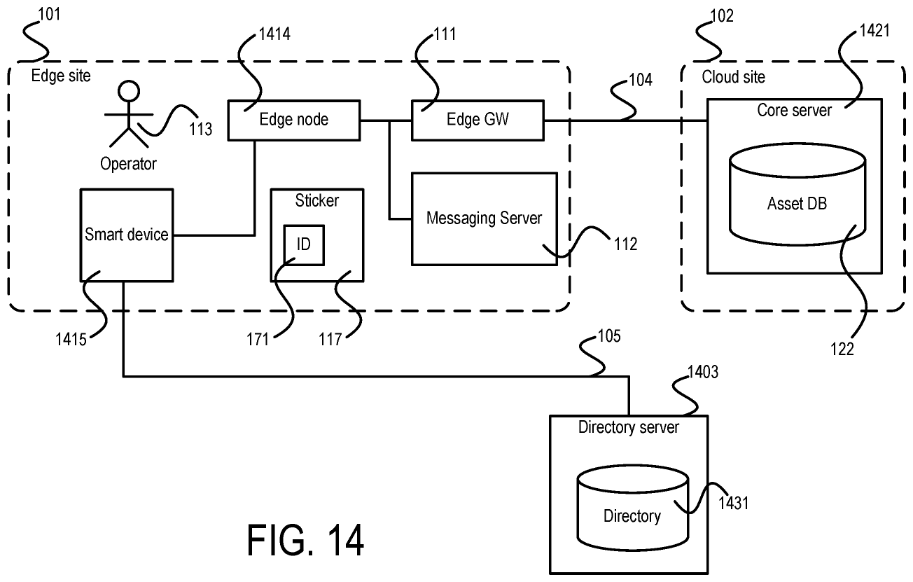

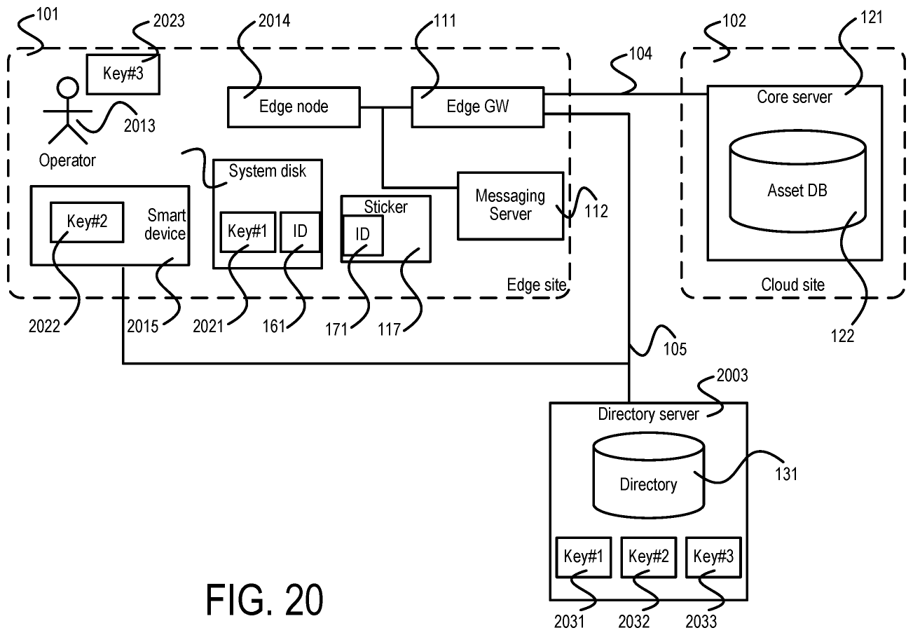

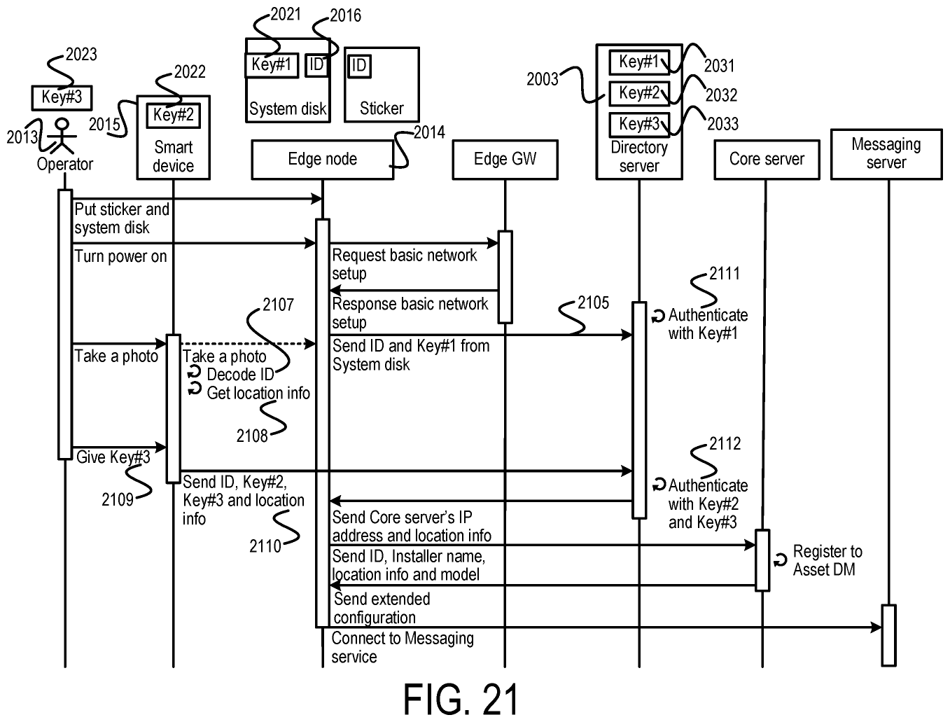

An example implementation is directed to automatic device configuration and registration methods for public network systems as described in reference to FIGS. 1-13. Another example implementation is directed to automatic device configuration and registration methods for systems without a public network connection between edge sites and cloud sites is as described in reference to FIGS. 14-19. An example aspect of the present disclosure includes an automatic device configuration and registration system with secure authentication as described in reference to FIGS. 20-21.

### First Example Implementation

FIG. 1 illustrates a system diagram of an example automatic device configuration and registration system in accordance with an example implementation. FIG. 1 shows the whole figure of the automatic device configuration and registration system. The example system includes at least one edge site 101, at least one cloud site 102 and a directory server 103. The edge site 101 and the cloud site 102 are connected by a network 104. The edge site 101 can connected to the directory server 103 by network 104 or another network 105 such as a public network. The directory server 103 can be hosted by a third a directory service provider that is shared by multiple companies that use the directory service.

The edge site 101 can involve an edge gateway (GW) 111 and a messaging server 112, and an operator 113. The operator 113 deploys a plethora of edge nodes 114 in different locations at the edge site 101. The operator 113 operates a smart device 115 (e.g., handheld computer, smartphone, etc.) and can use a system disk 116 and a sticker 117 for provisioning edge devices 114 as described herein. The smart device 115 is remotely connected to the directory server 103 (e.g., via the public network 105).

In an example implementation, a system disk 116 with an identifier (ID) 161 and a sticker 117 with ID 171 can include a common or associated ID 161 and 171. Each edge node 114 can be associated with one or multiple IDs 161 and 171. For example, the system disk 116 can store the ID 161 on a suitable place in a file system such as /etc/id.dat, and the sticker 117 can include the ID 171 as printed alphanumeric values, a barcode, hologram, or other means. In an example, ID 161 can be referred to as an electronic ID 161 stored in a non-transitory tangible media of the system disk 116. For example, electronic ID 161 can be read using communication protocols (e.g., wired, Bluetooth, near field communication, infrared, radio frequency, etc.). In an example, ID 171 can be referred to as an organic ID 171 that can include a unique identifier in a form that can be read without a network connection or independent of operation by the edge device 114. For example, organic ID 171 can be a printed ID such as a serial number or unique symbol on a sticker 117 that can be captured by a camera of the smart device 115 or input by the operator.

The operator 113 can assign the one or multiple IDs 161 and 171 to an edge node 114 or capture previously assigned IDs 161 and 171 using the smart device 115. In an example implementation, a pair involves the system disk 116 and the sticker 117 include the same identifier value such that the edge node 114 associated with the pair is identifiable by the electronic ID 161 and the organic ID 171. Thus, the edge node 114 can be identified by the electronic ID 161 via access to the system disk 116 and/or by the organic ID 171 independent of operation of the edge device 114.

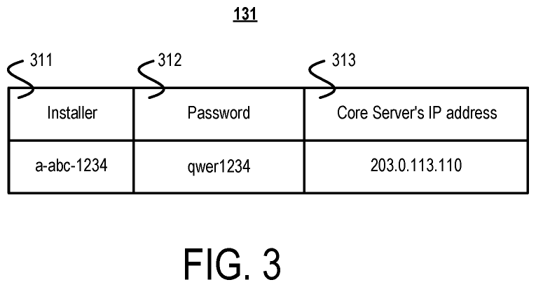

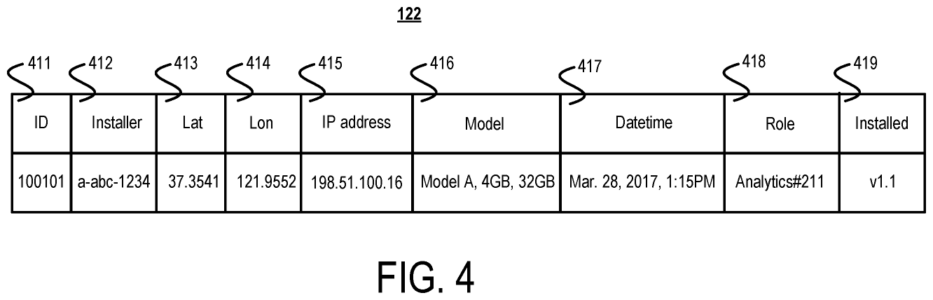

The cloud site 102 involves a core server 121 that includes an asset database (DB) 122 as described further in reference to FIG. 4. The directory server 103 includes the directory 131 as described further in reference to FIG. 3. The smart device 115 and the system disk 116 include endpoint information of the directory server 103 such as an Internet Protocol (IP) address of the directory server 103 or a host name of the directory server 103 as described further in reference to FIG. 3.

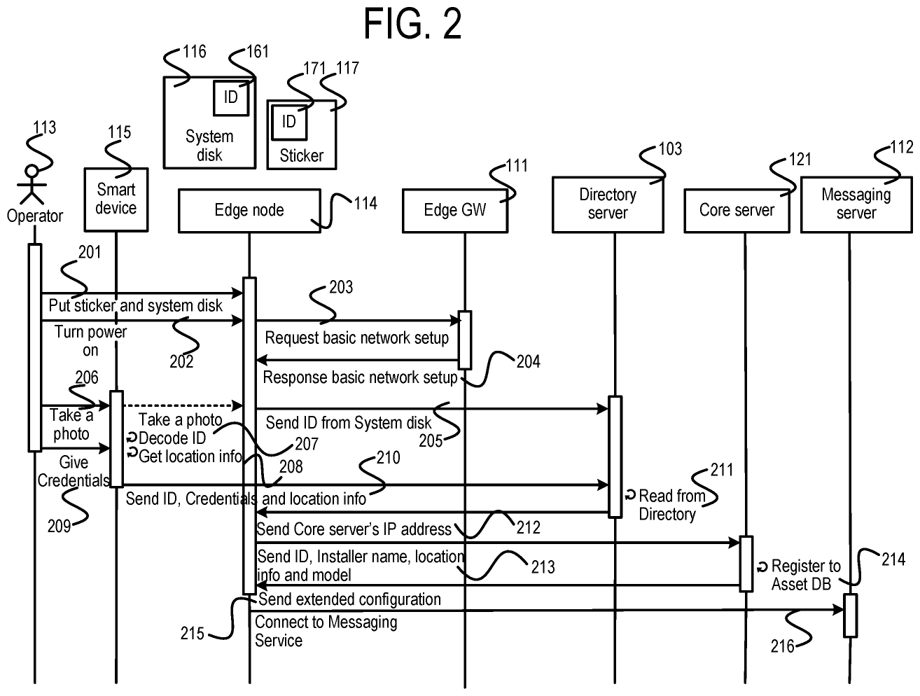

FIG. 2 illustrates an example sequence diagram for deploying a new edge node using the automatic device configuration and registration system in accordance with an example implementation. FIG. 2 shows the sequence diagram of deploying a new edge node by using the automatic device configuration and registration system. In an example implementation, at 201, the operator 113 puts the sticker 117 on the edge node 114 and inserts the system disk 116 into the edge node 114. The sticker 117 can display the organic ID 171, and the system disk 116 can include edge node programs, storage space for configuration information, and the electronic ID 161 that matches the organic ID 171.

At 202, the operator turns on the power of the edge node 114. At 203, the edge node 114 requests basic network setup information from the edge GW 111 by executing an edge node program from the system disk 116. The basic network setup information can includes network configuration information such as for the physical layer, data link layer, and network layer of the Open Systems Interconnection model (OSI model) and enable communication operations such as Universal Plug and Play (UPnP), Wi-Fi Protected Setup (WPS), Dynamic Host Configuration Protocol (DHCP), etc. At 204, the edge GW 111 returns the basic network setup information to the edge node 114.

At 205, the edge node 114 sends to the directory server 103 a first message with the ID 161 from the system disk 116. At 206, the operator 113 can capture a photo of the sticker 117 on the edge node using the smart device 115. In an example implementation, at 207, the smart device 115 decodes the photo of the sticker 117 to determine the organic ID 171.

At 208, the smart device 115 in proximity to the edge device 114 obtains location information, for example using a Global Positioning System (GPS) or any other locator device such as indoor location detector techniques. At 209, the operator 113 gives credentials to the smart device 115. For example, credentials can include a pair of an installer name and a password. At 210, the smart device 115 sends to the directory server 103 a second message including information indicating the ID 171, the credentials, and the location information.

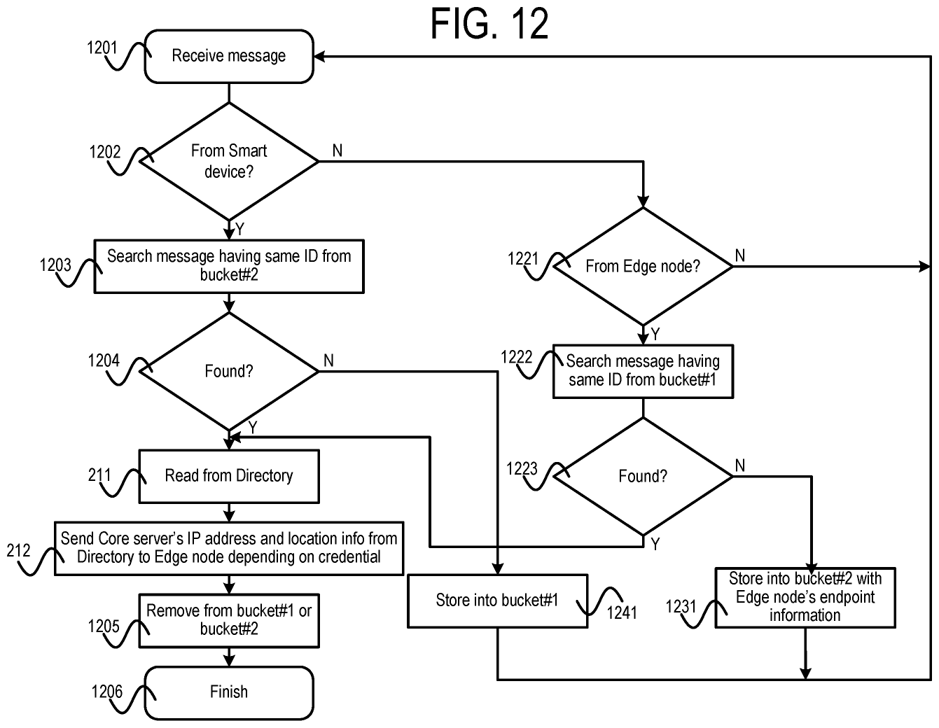

At 211, the directory server 103 compares the first message received at 205 and the second message received from 210 by using the electronic ID 161 and organic ID 171 to verify the edge node 114 is the correct device and is being installed/configured by the correct operator; and reads the core server's IP address from the directory 131, as further described in reference to FIG. 12. At 212, the directory server 103 sends endpoint information of the core server 121 such as IP address to the edge node 114. At 213, the edge node 114 sends the ID, the installer name, the location information and the model information to the core server 121. The model information is generated by a helper application such as display message or driver message command ‘dmesg’ of UNIX-based operation systems. At 214, the core server 121 registers the set of information that is received from the edge node 114 to the asset DB 122.

After that 215, the core server 121 sends the extended configuration to the edge node 114 to activate it. The extended configuration includes endpoint information of the messaging server 112 and credentials for connecting to the messaging server 112. At 216, the edge node 114 connects to the messaging server 112 in accordance with the extended configuration.

FIG. 3 illustrates an example directory 131 table in accordance with an example implementation. FIG. 3 shows the data schema of the directory 131 from directory server 103. The directory 131 includes credential information and the core server's endpoint information. For example, the directory 131 includes an installer column 311, a password column 312, and a core server's IP address column 313.

The installer column 311 stores a name of the installer (e.g., a-abc-1234) and the password column 312 stores a password of the installer (e.g., qwer1234). The installer column 311 and the password column 312 are related to credentials that are used by the system. For example, credentials can include a pair of the installer name and the password. The core server's IP address column 313 stores endpoint information (e.g., an IP address).

FIG. 4 illustrates an example asset database 122 table in accordance with an example implementation. The asset DB 122 includes an ID column 411, an installer column 412, a LAT column 413, a LON column 414, an IP address column 415, a model column 416, a datetime column 417, a role column 418, and an installed column 419. The ID column 411 stores an ID of each device that comes from the sticker 117 (e.g., 100101). The installer column 412 stores a name of the installer (e.g., a-abc-1234) that installs the device and that is related to the credential of directory 131 in FIG. 3.

The location information of where the device is installed is stored in the LAT column 413 and the LON column 414. The LAT column 413 stores a latitude information and the LON column 414 stores a longitude information; however other location information such as altitude, a photo that shows installation status, or an indoor positioning data can also be utilized in accordance with the desired implementation.

The IP address column 415 stores an IP address (e.g., 198.51.100.16) of the device. The IP address is related to the endpoint information of the device that is a sort of the location information in a cyber space. The model column 416 stores hardware related information (e.g., Model A, 4 GB, 32 GB) of the device. The hardware related information is generated by helper applications such as “dmesg” command of UNIX-based operation systems.

The datetime column 417 stores a timestamp of the when insertion of each row related to when the device is installed. For example, each row of the asset DB 122 is non-updatable and another row is inserted if any information update is required; however other time tracking techniques can also be utilized in accordance with the desired implementation. In an example implementation the asset DB 122 can be updated when the edge device is moved to a second location. For example, the smart device located in proximity to the edge device in the second location can determine the second location from the smart device, transmit information indicating the physical identifier and the second location to the asset DB 122, and the asset DB 122 can add a linked row with location information for the second location.

The role column 418 stores the role of the device and is set by asset managers. The installed column 419 stores a version number of software what is installed in the device.

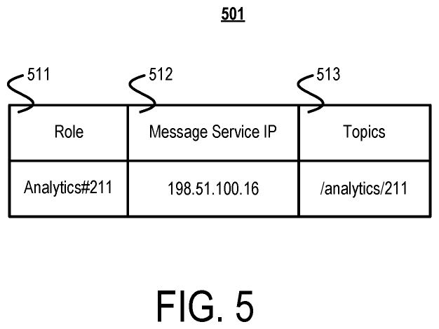

FIG. 5 illustrates an example configuration database 501 table in accordance with an example implementation. The configuration DB 501 includes the role information of each device and the message service's endpoint information. The role information and the message service's endpoint information are matched using the configuration DB 501. The configuration database 501 includes a role column 511, a message service IP address column 512 and a topics column 513. The role column 511 stores a role of devices (e.g., Analytics#211). The message server IP address column 512 stores an IP address of the message service server 112. The topics column 513 stores topic names (e.g., /analytics/211) of the messaging service 112. The message service IP address column 512 and the topics column 513 is related to the message service's endpoint information (e.g., a pair of the message service IP address and the topic names).

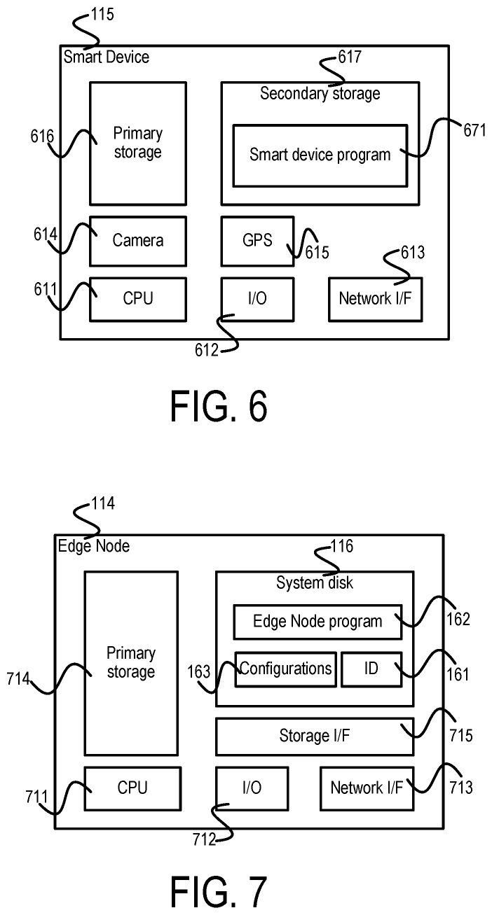

FIG. 6 illustrates a system diagram of an example smart device 115 in accordance with an example implementation. The smart device 115 includes a central processing unit (CPU) 611, an Input/Output (I/O) module 612, a network interface (I/F) module 613, a camera module 614, a GPS module 615, a primary storage 616, and a secondary storage 617. The camera module 614 can take photos of the sticker with enough resolution to analyze the image and decode the contents of the image.

The GPS module 615 can be used to obtain the location information; however other location means such as an indoor positioning system can also be utilized in accordance with the desired implementation. The secondary storage 617 is a persistent storage and includes a smart device program 671. The smart device program 671 describes operation steps of the smart device. The primary storage 616 is a volatile storage and can be used by the smart device program.

FIG. 7 illustrates a system diagram of an example edge device 114 in accordance with an example implementation. The edge node includes a CPU 711, an I/O module 712, a network I/F module 713, a primary storage 714, a storage I/F 715 and a system disk 116. The storage I/F 715 is the interface to connect the system disk 116. The system disk 116 is a removable and persistent storage such as secure digital (SD) card. The system disk 116 is inserted and connected to the storage I/F 715 by the operator 113. The system disk 116 includes an edge node program 162, a configuration 163 and the electronic ID 161. The edge node program 162 describes operation steps of the edge node 114. The configuration 163 includes information for the edge node program such as the installer name and the location information. The electronic ID 161 can match the organic ID 171 of the sticker 117 associated with the edge node 114.

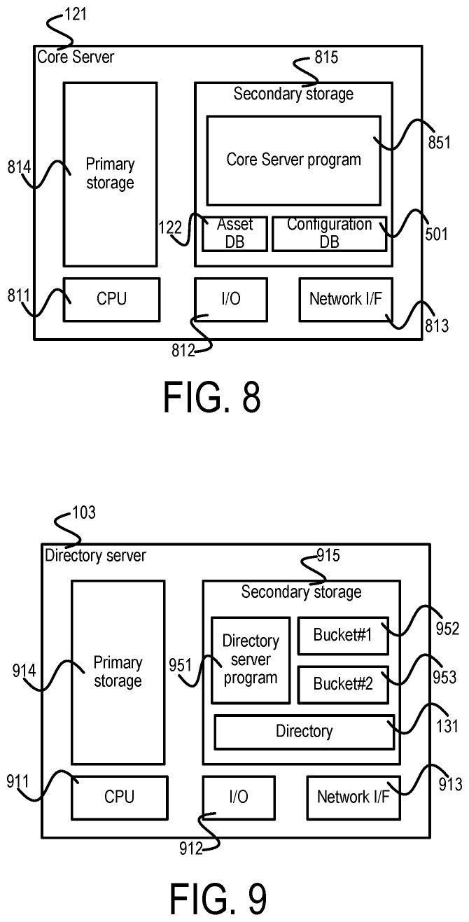

FIG. 8 illustrates a system diagram of an example core server 121 device in accordance with an example implementation. The core server 121 includes a CPU 811, an I/O module 812, a network I/F module 813, a primary storage 814, and a secondary storage 815. The secondary storage 815 is a persistent storage and includes a core server program 851, an asset DB 122 (e.g., asset DB 122 of FIG. 3) and a configuration DB 501 (e.g., configuration DB 501 of FIG. 5). The core server program describes operation steps of the core server.

FIG. 9 illustrates a system diagram of an example directory server 103 in accordance with an example implementation. The directory server 103 includes a CPU 911, an I/O module 912, a network I/F module 913, a primary storage 914, and a secondary storage 915. The secondary storage 915 is a persistent storage and includes a directory server program 951, a directory 131 (e.g., directory 131 of FIG. 3), a bucket#1 952 and bucket#2 953. The directory server program 951 describes operation steps of the directory server. The bucket#1 and the bucket#2 are temporal data stores that are used by the directory server program 951.

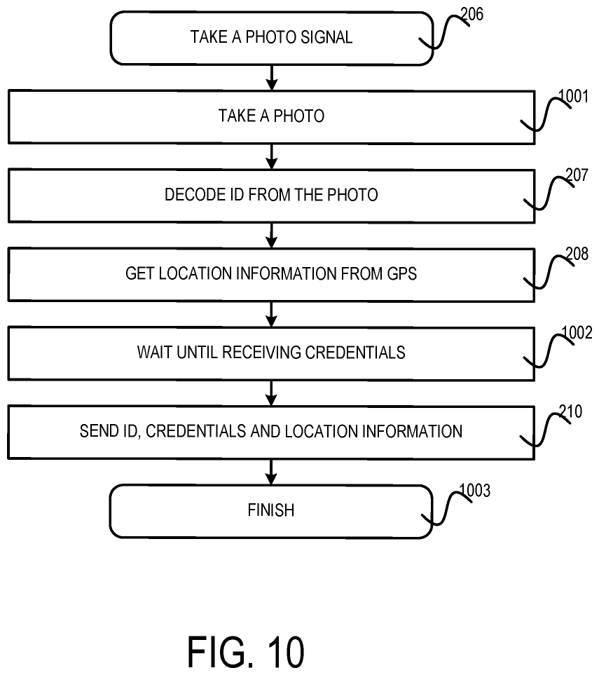

FIG. 10 illustrates a flow chart of an example smart device process in accordance with an example implementation. FIG. 10 shows a flow chart of the smart device. Firstly at 206, the smart device receives a request signal of taking a photo from the operator as shown on FIG. 2. At 1001, the smart device takes a photo. At 207, the smart device decodes an ID from the photo. At 208, the smart device gets a location information from GPS device. At 1002, the smart device waits until receiving credentials from the operator. At 210, the smart device sends the ID, the credentials and the location information to the directory server. At 1003, the smart device finishes the flow.

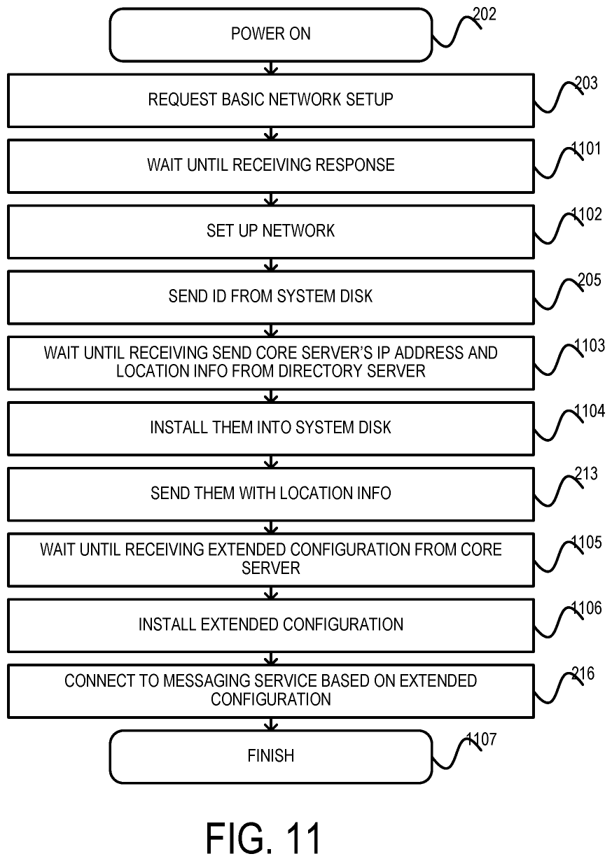

FIG. 11 illustrates a flow chart of an example edge device process in accordance with an example implementation. At 202, the operator 113 turns the edge node 114 power on. At 203, the edge node requests a basic network setup to the edge GW. At 1101, the edge node waits until receiving a response from the edge GW. After receiving the response, at 1102 the edge node sets-ups network by using the response from the edge GW. At 205, the edge node sends an ID from a system disk. At 1103, the edge node waits until receiving the core server's endpoint information such as IP address, the installer name from the credentials, and location the information from the directory server. After receiving core server's endpoint information, at 1104 the edge node installs the core server's endpoint information into the system disk including the IP address, the installer name from the credentials, and location the information.

At 213, the edge node sends the core server's endpoint information to the core server including the IP address, the installer name from the credentials, location the information, and the location information. At 1105, the edge node waits until receiving the extended configuration from the core server. After receiving extended configuration, at 1106 the edge node installs the extended configuration into the system disk. At 216, the edge node connects to a messaging service based on the extended configuration. At 1107, the edge node finishes the flow.

FIG. 12 illustrates a flow chart of an example directory server process in accordance with an example implementation. At 1201, the directory server receives a message A from smart devices or edge devices. At 1202, the directory server detects whether or not the message A is from the smart device. If the message A is from the smart device (Y), the directory server at 1203 searches for another message B from the bucket#2 that has the same ID as associated with the message A. Otherwise (N), the flow proceeds to 1221 described below.

At 1204, the directory server detects whether or not the message B is found or not. If at 1204 the message B is not found (N), the directory server stores the message A into the bucket#1 1241 and goes to the first step 1201.

If at 1204 the message B is found (Y), the directory server at 211 read the core server's IP address from the directory depending on the credential from the message A. At 212, the directory server sends the core server's IP address and the location info from the message A to the edge node from the message B. At 1205, remove the message B from the bucket#2. At 1206, the directory server finishes the flow.

If at 1202 the message A does not come from smart devices (N), the directory server detects whether or not the message A is came from edge node or not 1221. If at 1221 the message A comes from the edge node (Y), the directory server at 1222 searches for another message C from the bucket#1 with the same ID as the message A. If at 1221 the message A does not come from edge nodes (N), proceeds back to the first step 1201.

If at 1223 the message C is found (Y), the directory server returns to 211 to read from the director. If at 1223 the message C is not found (N), the directory server at 1231 stores the message A into the bucket#2 with the edge node's endpoint information and proceeds back to the first step 1201.

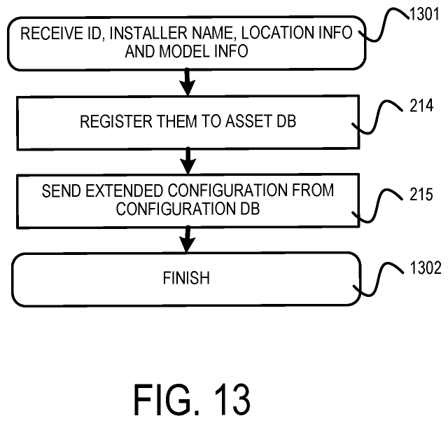

FIG. 13 illustrates a flow chart of an example core server process in accordance with an example implementation. At 1301, the core server receives an ID, an installer name, location information and model information from an edge node. At 214, the core server registers the ID, the installer name, the location information and the model information to the asset DB. At 215, the core server sends an extended configuration to the edge node from the configuration DB. At 1302, the core server finishes the flow.

### Second Example Implementation

FIG. 14 illustrates a system diagram of an example automatic device configuration and registration system with limited connectivity in accordance with an example implementation. FIG. 14 shows the whole figure of the automatic device configuration and registration system without public network connection between edge sites and cloud sites. In this example, the system includes at least one edge site 101, at least one cloud site 102, and one directory server 103. The edge site 101 and the cloud site 102 are connected by a network 104. The directory server 1403 is provided by the directory service provider and can be shared by companies that use the directory service.

For the second example implementation, the system of FIG. 14 is similar to the system FIG. 1 for the first example implementation. However, in the second example implementation, the operator 113 uses a smart device 1415 and a sticker 117 without the system disk of the first example implementation. In the second example implementation is compatible with edge nodes 1414 that do not have disk slot and the edge site 101 does not have any public network 105 connectivity.

The cloud site 102 includes a core server 1421 with the asset DB 122. The directory server 1403 includes the directory 131. The smart device 1415 includes endpoint information of the directory server 1403 such as an IP address of the directory server 1403 or a host name of the directory server 1403.

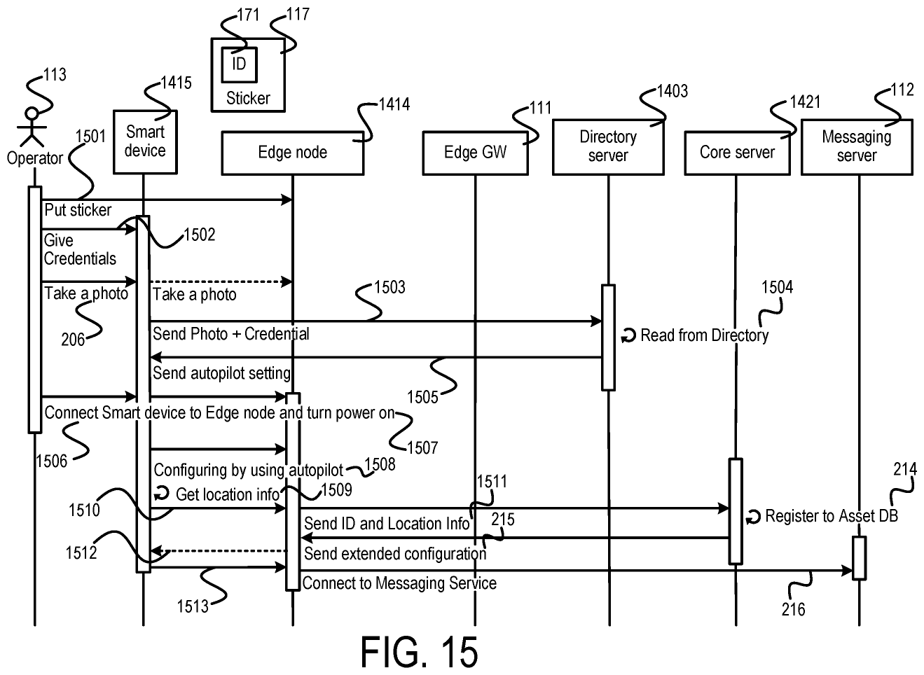

FIG. 15 illustrates a sequence diagram of an example new edge node deployment process with limited connectivity in accordance with an example implementation. At 1501, the operator 113 puts the sticker 117 on the edge node 1414 and the sticker 117 shows an organic ID 171, for example letters, bar codes (e.g., 2 dimensional bar codes), etc.

At 1502, the operator provides credentials (e.g., a pair of an installer name and a password) to the smart device 1415. At 206, the operator captures a photo of the sticker 117 showing the organic ID 171 on the edge node 1414 by using the smart device 1415. At 1503, the smart device 1415 sends the photo and the credentials to the directory server 1403.

At 1504, the directory server 1403 verifies the edge node 1414 is the right device and is installed by the right operator, and read the core server's IP address from the directory 1431. At 1505, the directory server 1403 sends an autopilot setting from a directory 1431 to the smart device 1415.

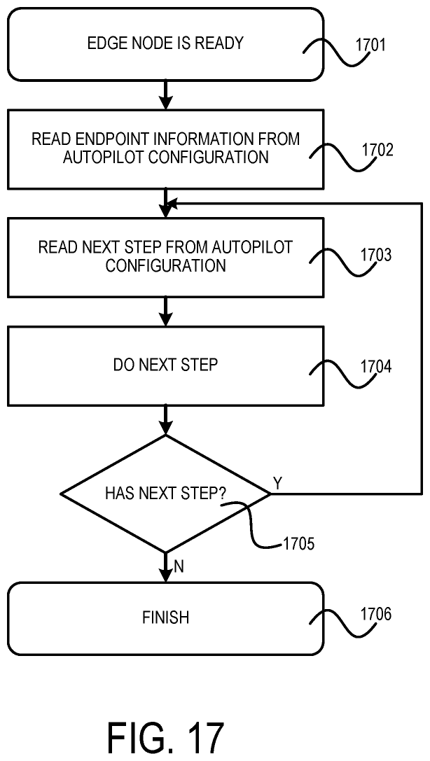

The autopilot settings can include instructions (e.g., a script) to automatically perform multiple steps of the provision process to install and configure the edge node as described in reference to FIGS. 17-19. In an example, different autopilot configurations can be designed based on different endpoint information (e.g., IP address), hardware (e.g., models), installers, etc. and include instructions with multiple steps. For example, autopilot configurations [endpoint] HTTP, /init can include [step1] set “Name of this device” as installer name; [step2] set “Server address” as core server's IP address; [set 3] . . . , etc.

At 1506 and 1507, the operator 113 connects the smart device 1415 to the edge node 1414 and turns on the power of the edge node 1414. Then at 1508, the smart device 1415 configures the edge node 1414 using the autopilot settings. At 1509 the smart device 1415 obtains location information, for example by GPS. At 1510 and 1511, the smart device sends the location information with the ID, and receives the extended configuration from the core server at 215.

At 214, the core server 1421 registers the set of information that is received from the edge node to the asset DB. After detecting the step 215 on step 1512, the edge node connects to the messaging server in accordance with the extended configuration 1513 and 216.

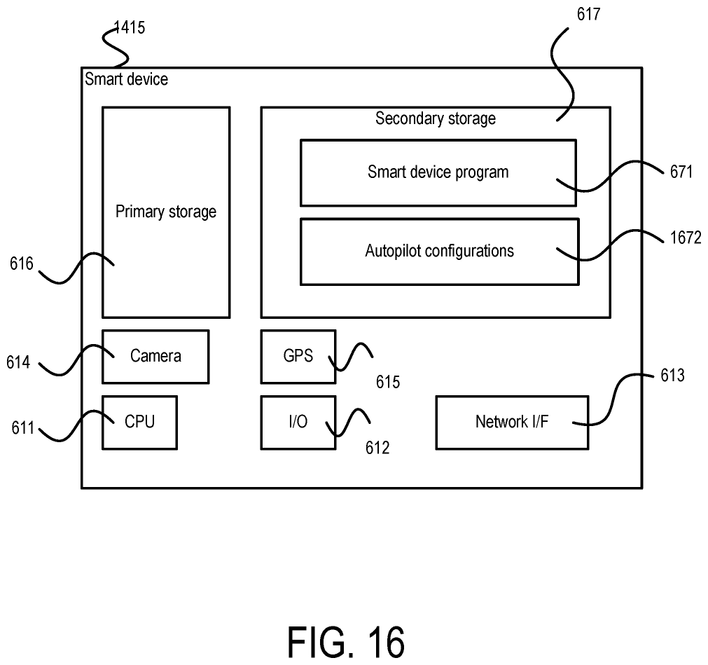

FIG. 16 illustrates a system diagram of an example smart device 1415 in accordance with an example implementation. The smart device 1415 is similar to FIG. 6 as described above and includes a CPU 611, an I/O module 612, a network I/F module 613, a camera module 614, a GPS module 615, a primary storage 616, and a secondary storage 617. In the second example implementation, the secondary storage of the smart device 1415 is a persistent storage and includes the smart device program 671 and further includes autopilot configurations 1672. In an example implementation, the autopilot configurations 1672 can include instructions (e.g., a script) to automatically perform multiple steps of the provision process to install and configure the edge node as described in reference to FIGS. 17-19.

FIG. 17 illustrates a flow chart of an example smart device process in accordance with an example implementation. At 1701, the smart device waits until the edge node is ready. At 1702, the smart device reads the endpoint information of the edge node from the autopilot configuration. At 1703, the smart device reads the next step from the autopilot configuration. At 1704, the smart device executes the next step that is read above for the edge node.

At 1705, the smart device detects whether or not the autopilot configuration has completed configuration and installation of the edge node or additional instructions are to be provided to the edge node. If at 1705 additional instructions are to be provided to the edge node (Y), then at 1703 the process returns to 1703 and the smart device reads the next step from the autopilot configuration. If at 1705 the autopilot configuration has completed and there are not additional instructions (N), then the processing is complete.

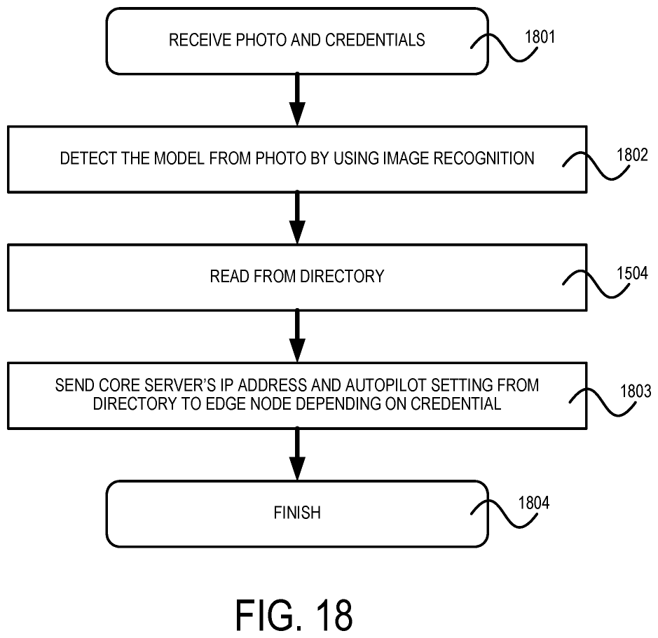

FIG. 18 illustrates a flow chart of an example directory server process in accordance with an example implementation. At 1801, the directory server receives a photo and credentials from the smart device. At 1802, the directory server detects the model of the smart device based on an image recognition function. That is, the directory server can include an image recognition function to analyze the photo, perform image recognition, and decode contents to extract information.

At 1504, the directory server reads the core server's IP address from the directory depending on the credential and model information recognized from the photo. At 1803, the directory server sends a core server's IP address and an autopilot configuration from the directory to the edge node depending on the credential. At 1804, the directory server finishes the flow.

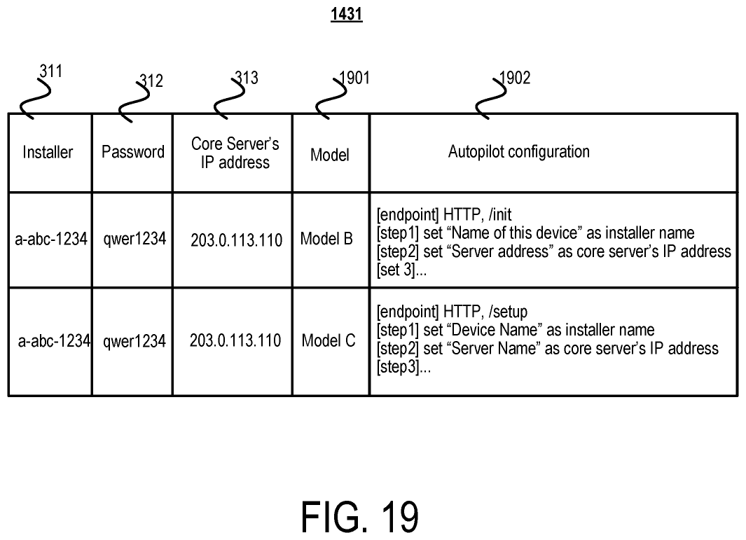

FIG. 19 illustrates an example directory 1431 table in accordance with an example implementation. The directory 1431 includes the credential information 311 and 312, the core server's endpoint information 313 (e.g., IP address), model information 1901, and autopilot configuration 1902. The autopilot configuration 1902 column stores description of how to configure the edge device as shown on the model column 1901 and includes the endpoint information 313. In an example, autopilot configuration description of how to configure the edge device can include commands [endpoint] HTTP, /init and multiple steps for Model B [step1] set “Name of this device” as installer name; [step2] set “Server address” as core server's IP address; [set 3] . . . , etc. In another example, autopilot configuration description for Model C includes [endpoint] HTTP, /setup; [step1] set “Device Name” as installer name; [step2] set “Server Name” as core server's IP address; [step3] . . . , etc.

### Third Example Implementation

FIG. 20 illustrates a system diagram of an example automatic device configuration and registration system in accordance with an example implementation. FIG. 20 shows the whole figure of the secure automatic device configuration and registration system. The system includes additional multi-factor authentication that can increase security. In this example, the system disk 2016 includes key#1 2021, the smart device 2015 includes key#2 2022 and the operator 2013 has or knows key#3 2023. The directory server 2003 includes the counter parts of key#1 2031, key#2 2032 and key#3 2033 for completing the authentication. The system is compatible with a variety of authentication method including but not limited to common key method, public key method, password method, fingerprint method, etc.; however other authentication techniques can also be utilized in accordance with the desired implementation.

FIG. 21 illustrates a sequence diagram of an example new edge node secure deployment process in accordance with an example implementation similar to first example implementation discussed in reference to FIG. 2. FIG. 21 shows the sequence diagram of deploying a new edge node by using the secure automatic device configuration and registration system. In this example implementation, the edge node 2014 sends key#1 2021 with ID to the directory server 2003 on the step 2105. At 2109, the operator gives key#3 2023 to the smart device 2015. At 2110, the smart device 2015 send the key#2 2022 and given key#3 2023 with ID to the directory server 2003. At 2111, the directory server authenticate with key#1 2021 and 2031, At 2112, the directory server performs the authentication with key#2 2022 and 2032 and key#3 2023 and 2033.

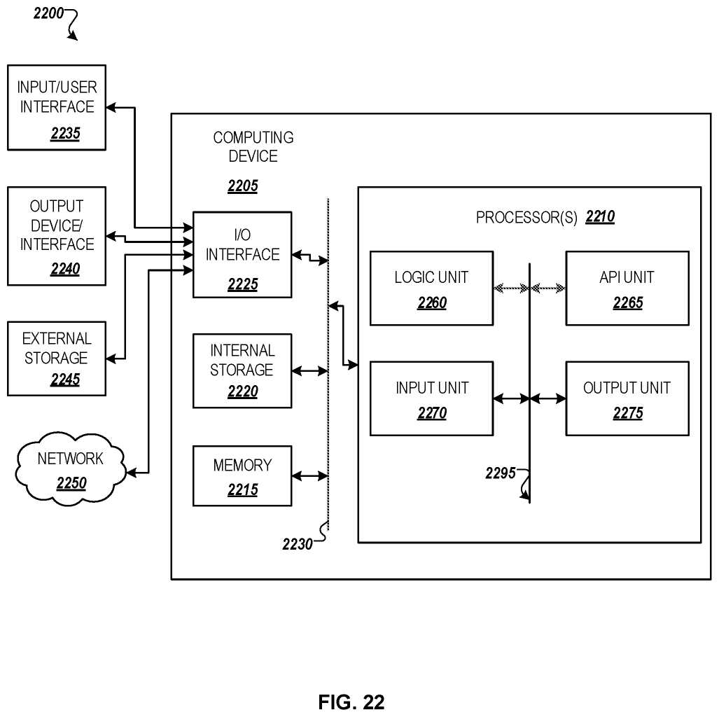

FIG. 22 illustrates an example computing environment with an example computer device suitable for use in some example implementations. FIG. 22 illustrates an example computing environment 2200 with an example computer device suitable for use in some example implementations, such as for facilitating a device deployment with automatic configuration and asset management as illustrated in FIGS. 1-21. Computer device 2205 in computing environment 2200 can include one or more processing units, cores, or processors 2210, memory 2215 (e.g., RAM, ROM, and/or the like), internal storage 2220 (e.g., magnetic, optical, solid state storage, and/or organic), and/or I/O interface 2225, any of which can be coupled on a communication mechanism or bus 2230 for communicating information or embedded in the computer device 2205.

Computer device 2205 can be communicatively coupled to input/user interface 2235 and output device/interface 2240. Either one or both of input/user interface 2235 and output device/interface 2240 can be a wired or wireless interface and can be detachable. Input/user interface 2235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2240 may include a display, television, monitor, printer, speaker, braille, or the like. In some example implementations, input/user interface 2235 and output device/interface 2240 can be embedded with or physically coupled to the computer device 2205. In other example implementations, other computer devices may function as or provide the functions of input/user interface 2235 and output device/interface 2240 for a computer device 2205.

Examples of computer device 2205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2205 can be communicatively coupled (e.g., via I/O interface 2225) to external storage 2245 and network 2250 for communicating with any number of networked components, devices, and systems, including one or more computer devices of the same or different configuration. Computer device 2205 or any connected computer device can be functioning as, providing services of, or referred to as a server, client, thin server, general machine, special-purpose machine, or another label.

I/O interface 2225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2200. Network 2250 can be any network or combination of networks (e.g., the Internet, local area network, wide area network, a telephonic network, a cellular network, satellite network, and the like).

Computer device 2205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2210 can execute under any operating system (OS) (not shown), in a native or virtual environment. One or more applications can be deployed that include logic unit 2260, application programming interface (API) unit 2265, input unit 2270, output unit 2275, and inter-unit communication mechanism 2295 for the different units to communicate with each other, with the OS, and with other applications (not shown). The described units and elements can be varied in design, function, configuration, or implementation and are not limited to the descriptions provided.

In some example implementations, when information or an execution instruction is received by API unit 2265, it may be communicated to one or more other units (e.g., logic unit 2260, input unit 2270, output unit 2275). In some instances, logic unit 2260 may be configured to control the information flow among the units and direct the services provided by API unit 2265, input unit 2270, output unit 2275, in some example implementations described above. For example, the flow of one or more processes or implementations may be controlled by logic unit 2260 alone or in conjunction with API unit 2265.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “obtaining” “receiving,” “determining,” “transmitting,” “providing,” “configuring,” “installing,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

For a smart device located in proximity to the edge device, the processor 2210 is configured to obtain a photo of a physical identifier of the edge device and determine a location from the smart device as illustrated in FIG. 2 at 206, 207, 208, and FIG. 10 at 206, 1001, 207, 208, 1002, 212. In an example implementation, the set of configuration information is based on the location from the smart device as illustrated in FIG. 2 at 208, FIG. 6 at 615, FIG. 10 at 208, FIG. 15 at 1509, FIG. 16 at 615, and FIG. 21 at 2108.

In an example implementation, processor 2210 is configured to analyze the photo to determine the physical identifier as illustrated in FIG. 1 at 117, 171, FIG. 2 at 207, FIG. 10 at 207, and FIG. 21 at 1507. In an example implementation, processor 2210 is configured to receive an electronic identifier from the edge device as illustrated in FIG. 1 at 161, FIG. 2 at 205, FIG. 7 at 161, and FIG. 11 at 205, 1104. In an example implementation, the data server is to analyze the photo to determine the physical identifier as illustrated in FIG. 15 at 1504, and FIG. 18 at 1801, 1802, 1504.

The processor 2210 is configured to transmit information indicating the physical identifier and the location to a data server and receive a set of configuration information as illustrated in FIG. 2 at 210, FIG. 10 at 210, FIG. 12 at 1201, FIG. 13 at 1301, FIG. 15 at 1503, and FIG. 18 at 1801,

The processor 2210 is configured to provide the set of configuration information to the edge device, wherein the edge device is configured based on the set of configuration information independent of communication with the data server as illustrated in FIG. 2 at 211, 212, 213, 215, 216, FIG. 11 at 1103, 1104, 213, 1105, 1106, 215, FIG. 12 at 212, FIG. 13 at 215, FIG. 15 at 1508, 1509, 1511, 214, 215, 1512, 1513 and FIG. 21.

In an example implementation, the edge device is configured using a script based on the set of configuration information, wherein the script includes parameters from the smart device. as illustrated in FIG. 11 at 1103, 1104, 213, 1105, 1106, 215, FIG. 12 at 212, FIG. 13 at 215, FIG. 15 at 1508, 1509,1511, 214, 215, 1512, 1513, FIG. 17 at 1701, 1702, 1703, 1704, 1705, 1706, FIG. 18 at 1803, and FIG. 19 at 1902.

In an example implementation, the processor 2210 is configured to obtain an operator authentication key, and transmit the information further comprising the operator authentication key and a smart device authentication key to the data server as illustrated in FIG. 21 at 2109, 2022, and 2110.

In an example implementation, the edge device is in a second location, and the processor 2210 is configured to determine the second location from the smart device; transmit information indicating the physical identifier and the second location to a data server; receive a second set of configuration information; and provide the second set of configuration information to the edge device, wherein the edge device is configured based on the second set of configuration information independent of communication with the data server as illustrated in FIG. 4 at 417, and FIG. 12 at 1204.

Through the example implementations described herein, an edge device asset can be registered and configured using a smart device using wired, low power, and/or limited range communication including with a camera that can capture a physical identifier of an edge device.

The edge device may initially not be connected to any networked system, have limited connectivity, limited computing capability, and/or be operated by customized software and cannot communicate directly to a directory server for registration (e.g., provide data to a cloud or a management server) through a desired communication protocol. Such example implementations further allow for configuration of edge devices with limited computing capability while facilitating efficient registration and configuration to capture an identifier and location of such devices without having large costly registration functionality residing locally on each edge device.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system for provisioning an edge device comprising:
a memory; and
a processor of a smart device located in proximity to the edge device configured to:
obtain a photo of a physical identifier of the edge device;
determine a location from the smart device;
transmit information indicating the physical identifier and the location to a data server;
receive a set of configuration information; and
provide the set of configuration information to the edge device, wherein the edge device is configured based on the set of configuration information independent of communication with the data server.

2. The system of claim 1, wherein the set of configuration information is based on the location from the smart device.

3. The system of claim 1, wherein the processor is further configured to analyze the photo to determine the physical identifier.

4. The system of claim 1, wherein the processor is further configured to receive an electronic identifier from the edge device.

5. The system of claim 1, wherein the data server is to analyze the photo to determine the physical identifier.

6. The system of claim 1, wherein the edge device is configured using a script based on the set of configuration information, wherein the script comprises parameters from the smart device.

7. The system of claim 1, wherein the processor is further configured to:
obtain an operator authentication key; and
transmit the information further comprising the operator authentication key and a smart device authentication key to the data server.

8. The system of claim 1, wherein the edge device is in a second location, the processor is further configured to
for the smart device located in proximity to the edge device in the second location:
determine the second location from the smart device;
transmit information indicating the physical identifier and the second location to a data server;
receive a second set of configuration information; and
provide the second set of configuration information to the edge device, wherein the edge device is configured based on the second set of configuration information independent of communication with the data server.

9. A method for provisioning an edge device comprising:
for a smart device located in proximity to the edge device:
obtaining, by the smart device, a photo of a physical identifier of the edge device;
determining a location from the smart device;
transmitting information indicating the physical identifier and the location to a data server;
receiving a set of configuration information; and
providing the set of configuration information to the edge device, wherein the edge device is configured based on the set of configuration information independent of communication with the data server.

10. The method of claim 9, wherein the set of configuration information is based on the location from the smart device.

11. The method of claim 9, further comprising analyzing the photo to determine the physical identifier.

12. The method of claim 9, further comprising receiving an electronic identifier from the edge device.

13. The method of claim 9, wherein the data server is to analyze the photo to determine the physical identifier.

14. The method of claim 9, wherein the edge device is configured using a script based on the set of configuration information, wherein the script comprises parameters from the smart device.

15. The method of claim 9, further comprising:
obtaining an operator authentication key; and
transmitting the information further comprising the operator authentication key and a smart device authentication key to the data server.

16. The method of claim 9, wherein the edge device is in a second location, the method further comprising:
for the smart device located in proximity to the edge device in the second location:
determining the second location from the smart device;
transmitting information indicating the physical identifier and the second location to a data server;
receiving a second set of configuration information; and
providing the second set of configuration information to the edge device, wherein the edge device is configured based on the second set of configuration information independent of communication with the data server.

17. A non-transitory computer-readable medium storing instructions for provisioning an edge device, the instructions executed by a processing device, the instructions comprising:
for a smart device located in proximity to the edge device:
obtaining, by the smart device, a photo of a physical identifier of the edge device;
determining a location from the smart device;
transmitting information indicating the physical identifier and the location to a data server;
receiving a set of configuration information;
providing the set of configuration information to the edge device, wherein the edge device is configured based on the set of configuration information independent of communication with the data server.

18. The non-transitory computer-readable medium of claim 17, further comprising analyzing the photo to determine the physical identifier.

19. The non-transitory computer-readable medium of claim 17, further comprising receiving an electronic identifier from the edge device.

20. The non-transitory computer-readable medium of claim 17, wherein the data server is to analyze the photo to determine the physical identifier.
